(19) United States
(12) Patent Application Publication
(10) Pub. No.: US 2005/0125566 A1
(43) Pub. Date: Jun. 9, 2005

(54) Storage capacity indicator for removable mass storage device

(76) Inventors: Thomas Szolyga, Saratoga, CA (US); Jean-Paul Moiroux, Los Altos, CA (US); Yancy Chen, Campbell, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/732,774

(22) Filed: Dec. 9, 2003

(51) Int. Cl. G06F 3/00

(52) U.S. Cl. 710/1

(57) ABSTRACT

A mass storage device, such as a removable hard disk, stores data and has an overall storage capacity. The mass storage device includes a panel on which a capacity indicator is positioned, and the capacity indicator displays either a used storage capacity or a free storage capacity of the mass storage device, or displays both free and used storage capacities of the mass storage device. The capacity indicator may be, for example, one or more light emitting diodes (LEDs), or may be an LED or liquid crystal display indicating percentage of the overall storage capacity of the mass storage device that is used, available, or both. A capacity-update program executing on a computer system of which the mass storage device is a part can update the storage capacity information being displayed, or suitable circuitry or a program within the device itself can update such information.

### TECHNICAL FIELD

The present application relates generally to computer systems, and more specifically to removable mass storage or other types of removable devices for computer or other electronic systems.

### BACKGROUND OF THE INVENTION

Modern computer systems include mass storage devices such as hard drives for storing application programs to be executed by the computer system, and for storing data utilized by such programs as well as other data desired to be stored by users of the system. A hard disk is a magnetic disk on which data is stored, and the storage density of a hard disk is the amount of data that can be stored in a given area of the disk. As the storage density of hard drives has increased, meaning that more data can be stored on smaller disks, physically smaller drives having relatively large storage capacities have become possible.

Physically smaller hard drives have led to removable drives, where a removable drive is a hard drive that can easily be plugged into and removed from a drive bay in the computer system. Removable hard drives make it easier to back up data and to transfer data from one computer to another, and also enable a user to more easily replace a defective drive and to upgrade software for the computer system. Furthermore, removable drives provide improved data security in many environments because a removable drive can be removed from the associated computer system and stored in a safe location when desired. Hard drives are the type of removable device being discussed herein merely for ease of description, and one skilled in the art will appreciate that the principles described herein apply equally well to other types of mass storage devices such as traditional fixed hard disks, magnetic-tape drives, CD-RW drives, and DVD-RW drives, as well as to other types of removable storage devices like USB drives.

Any removable mass storage device has a finite storage capacity, and thus only a certain amount of data can be stored on the device, where the term data applies to any information stored on the removable mass storage device including program files, text files, data files, and so on. With conventional removable mass storage devices, a user of a computer system containing the drive does not know how much space is left available on the device unless he actively determines this information through seldom used commands. For example, in Windows XP Version 2002, one way a user can determine the space available on a removable mass storage device is to click <Start>, <My Computer>, right click on the desired removable mass storage device, and then select <Properties>. The <General> tab of <Properties> shows the total capacity of the device and a pie chart shows the used and free space on the device. Another approach, for those familiar with the old DOS operating system, is to click <Start>, <All Programs>, <Accessories>, <Command Prompt>, and then type the DOS command “Dir X:” where X is the letter designation assigned to the removable drive of interest.

Either of these approaches requires a person to remember these esoteric commands, and also requires affirmative action by the user to obtain the desired capacity information. As a result, a user typically will not know a removable mass storage device has insufficient capacity until either the user or a program attempts to store data on the device. In this situation, the operating system displays a notice indicating there is insufficient capacity on the removable mass storage device to store the desired data. The user must at this point either delete some data from the device to make room for the desired data, or insert another removable mass storage device. While it may not be a problem to simply insert another removable mass storage device, or to add an additional device to increase the overall storage capacity of the system, a user may not have another drive available. As a result, the user may be delayed and in other ways inconvenienced when a removable mass storage device is full.

There is need for a system and method of easily conveying to a user of a computer system information regarding the available storage capacity of a removable mass storage device in the system.

### SUMMARY OF THE INVENTION

According to one aspect of the present invention, a mass storage device, such as a removable hard disk, stores data and has an overall storage capacity. The mass storage device includes a panel on which a capacity indicator is positioned, and the capacity indicator displays either a used storage capacity or a free storage capacity of the mass storage device, or displays both free and used storage capacities of the mass storage device. The capacity indicator may be, for example, one or more light emitting diodes (LEDs), or may be an LED or liquid crystal display indicating percentage of the overall storage capacity of the mass storage device that is used, available, or both. A capacity-update program executing on a computer system of which the mass storage device is a part can update the storage capacity information being displayed, or suitable circuitry or a program within the device itself can update such information.

### BRIEF DESCRIPTION OF THE DRAWINGS

FIG. 1 is a functional block diagram of a computer system including a removable mass storage device having a capacity indicator that displays capacity information for the mass storage device according to one embodiment of the present invention.

FIG. 2 is a functional isometric view of the removable mass storage drive of FIG. 1 showing in more detail one embodiment of the capacity indicator.

FIG. 3 is a functional isometric view of the removable mass storage drive of FIG. 1 showing in more detail another embodiment of the capacity indicator.

### DETAILED DESCRIPTION OF PREFERRED EMBODIMENTS

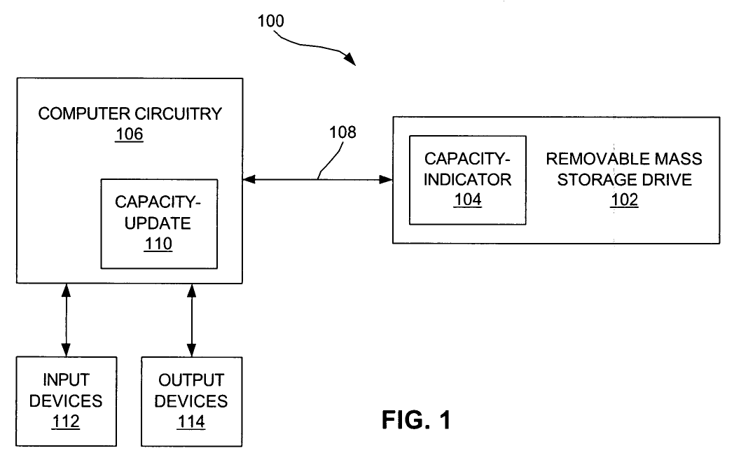

FIG. 1 is a functional block diagram of a computer system 100 including a removable mass storage device 102 having a capacity indicator 104 that displays storage capacity information for the mass storage device according to one embodiment of the present invention. The storage capacity information displayed by the capacity indicator 104 allows a user of the computer system 100 to easily determine the used and available storage capacity of the removable mass storage device 102, and to take appropriate action, such as installing an additional mass storage device, responsive to the displayed storage capacity. In this way, the capacity indicator 104 eliminates the need for a user to remember and enter esoteric commands simply to determine the used and available storage capacity of the removable mass storage device 102.

In the following description, certain details are set forth in conjunction with the described embodiments of the present invention to provide a sufficient understanding of the invention. One skilled in the art will appreciate, however, that the invention may be practiced without these particular details. Furthermore, one skilled in the art will appreciate that the example embodiments described below do not limit the scope of the present invention, and will also understand that various modifications, equivalents, and combinations of the disclosed embodiments are within the scope of the present invention. Finally, the operation of well known components or conventional techniques have not been shown or described in detail below to avoid unnecessarily obscuring the present invention.

In the computer system 100, the removable mass storage drive 102 communicates with computer circuitry 106 through a suitable communications link 108 such as an enhanced integrated drive electronics (EIDE) interface, which is an interface standard for transferring data between computer circuitry and mass storage devices such as the removable mass storage drive 102, as will be understood by those skilled in the art. The removable mass storage drive 102 is inserted in a suitable drive bay (not shown) of the computer system 100, with the drive bay providing the electrical interconnection to the computer circuitry 106 via the link 108 and physically containing the removable mass storage drive. Although only a single removable mass storage drive 102 is shown in FIG. 1, the computer system 100 may include multiple removable mass storage drives and associated drive bays, and may include nonremovable or “fixed” mass storage drives as well.

The computer circuitry 106 typically includes a processor (not shown) for performing various computing functions such as running the operating system of the computer system 100, executing desired software or programs to perform specific tasks, and writing data to and reading data from the removable mass storage drive 102 via the communications link 108. The computer circuitry 106 also typically includes system memory (not shown) formed from dynamic random access memory (DRAM) and static random access memory (SRAM) that operates as a cache, with the system memory storing programs and associated data for programs currently being executed by the computer circuitry. The computer circuitry 106 further includes a capacity-update program or component 110 which executes to update the storage capacity information displayed by the capacity indicator 104 of the removable mass storage drive 102, as will be described in more detail below.

The computer system 100 further typically includes one or more input devices 112, such as a keyboard or a mouse, coupled to the computer circuitry 106 to allow an operator to interface with the computer system. Typically, the computer system 100 also includes one or more output devices 114 coupled to the computer circuitry 106, such as a printer and a video terminal.

In operation, the removable mass storage drive 102 communicates with software executing on the computer circuitry 106 via the link 108. The software executing on the computer circuitry 102 activates the capacity-update component 110 which, in turn, begins executing to update the storage capacity information displayed by the capacity indicator 104 on the removable mass storage drive. More specifically, as software on the computer circuitry 106 executes various programs, portions of the removable mass storage drive 102 are allocated to store data in the form of program and data files. As the software executing on the computer circuitry 106 allocates portions of the removable mass storage drive 102, the capacity of the drive is consumed.

The capacity-update component 110 executes to occasionally determine the used and/or available capacity of the removable mass storage drive 102 as the software executing on the computer circuitry 106 allocates portions of this drive during operation. Once the capacity-update component 110 determines the current used and/or available capacity of the drive 102, the component communicates capacity-update signals to the drive over the communications link 108. The capacity determined by the capacity-update component 110 depends on the precise storage capacity information being displayed by the capacity indicator 104, as will be discussed in more detail below. In response to the capacity-update signals, the removable mass storage drive 102 updates the storage capacity information displayed by the capacity indicator 104. In this way, the capacity-update component 110 automatically updates the storage capacity information displayed by the capacity indicator 104, providing a user of the computer system 100 with real time information regarding the storage capacity of the removal mass storage drive 102.

The storage capacity information displayed by the capacity indicator 104 may vary. For example, the capacity indicator 104 could display utilized storage capacity as a percentage of an overall storage capacity of the removable mass storage drive 102. Alternatively, the capacity indicator 104 could display utilized storage capacity in gigabytes, or could display available storage capacity information as a percentage of overall storage capacity or in gigabytes, or could display both utilized and available storage capacities in either form. The information determined by the capacity-update component 110 in generating the capacity-update signals depends, of course, on the precise storage capacity information being displayed by the indicator 104. In other embodiments of the capacity indicator 104, the indicator may display different colors, each color representing a respective characteristic of used or available capacity on the storage drive 102. For example, green could represent 0-50% of capacity of the drive 102, yellow 51-75%, and red 76-100%, thus letting user know at a quick glance how much capacity of the drive 102 is used and therefore how much remains.

The capacity indicator 104 may have any form that provides used and/or available storage capacity information of the drive 102. For example, in another embodiment the capacity indicator 104 provides an audible indication of the capacity of the drive 102. The audible indication could be a voice occasionally stating the used and available storage capacity of the drive 102, or a voice or tone in the form of a capacity warning indicating there is only some relatively small amount—such as 10%—of the total storage capacity available on the drive 102. Thus, as used herein, the term “displays” as used with regard to capacity information includes visually and audibly providing such information, and includes other ways of providing such information as well, such as through providing a vibration. In another embodiment, the capacity indicator 104 provides capacity information even when the storage drive 102 is disconnected from the computer system 100. This provides a user with information about the remaining storage capacity of the drive 102 when, for example, the drive is sitting on a shelf and the user is selecting a drive to connect to the computer system 100.

Although the capacity indicator 104 is shown as being contained in the drive 102 in the embodiments described above, this need not be the case. In other embodiments, some other component of the computer system 100 provides the capacity information and thus may be considered as containing the capacity indicator 104. For example, in another embodiment a monitor corresponding to one of output devices 114 automatically provides a graphical display of the capacity information of the drive 102. Thus, a user need not know and enter esoteric keystrokes to obtain such information, but instead is automatically provided with such information on the monitor. The precise form of such a graphical display may vary, with the display including text, graphics, or both. Moreover, the precise manner in which the graphical display is provided may also vary. For example, the graphical display could be continually provided on the monitor, or could periodically be displayed to provide a user with capacity updates, or could require the user enter some simple keystrokes to obtain the information, such as clicking on an icon placed on a task bar or other similar portion of a monitor display.

The manner in which the capacity-update component 110 generates the capacity-update signals may similarly vary. For example, the capacity-update component 110 could periodically determine the used or available capacity of the drive 102 and generate the corresponding capacity-update signals to update the information displayed by the indicator 104. Alternatively, the capacity-update component 110 could generate the capacity-update signals responsive to the computer circuitry 106 accessing the drive 102 to transfer data to or from. In another embodiment, the capacity-update component 110 communicates new capacity-update signals to the drive 102 only when a change in the information being displayed by the indicator 104 must be made. For example, if the indicator 104 displays used capacity in gigabytes, then only when a full additional gigabyte of capacity of the drive 102 is consumed will the component 110 provide the capacity-update signals to the drive to update the indicator 104. In this way, updates are not provided to the indicator 104 that would not result in the displayed information changing, such as fractions of gigabytes of capacity in the present example. The specific operation of the capacity-update component 110 will vary depending on the embodiment of the capacity indicator 104 being utilized. Software or hardware for forming the component 110 in these various embodiments will be understood by those skilled in the art, as will suitable circuitry or software for forming the various embodiments of the capacity indicator 104.

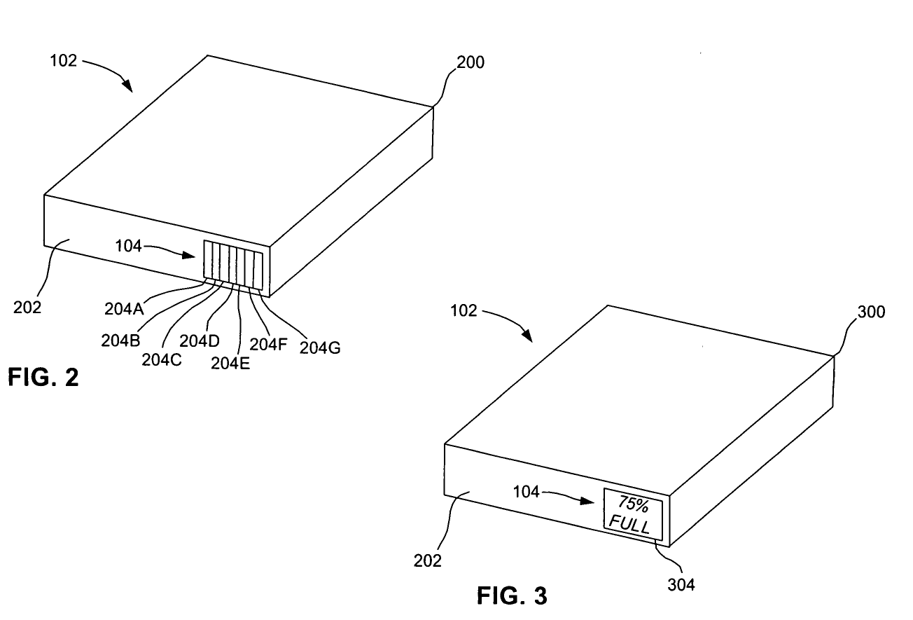

FIG. 2 is a functional isometric view of the removable mass storage drive 102 of FIG. 1 showing in more detail one embodiment of the capacity indicator 104. The removable mass storage drive 102 includes a housing 200 in which electronic components (not shown) of the drive are contained, and includes a front panel 202 on which the capacity indicator 104 is positioned. In the embodiment of FIG. 2, the capacity indicator 104 is formed by a plurality of individual LEDs 204a-g that collectively form a bar graph. In operation, the capacity-update component 110 generates the capacity-update signals to progressively illuminate the LEDs 204a-g as the utilized storage capacity of the drive 102 increases. Thus, when only a small portion of the capacity of drive 102 is utilized, the LED 204a is illuminated, and as more capacity is utilized the LED 204b is illuminated, then the LED 204c, and so on until the LED 204g is illuminated, indicating the drive is full or nearly full.

In one embodiment, the LEDs 204 are different colors, with, for example, LEDs 204a,b,c being green, LEDs 204d,e being yellow, and LEDs 204f,g being red. In this way, a user knows that when he sees a red LED 204f,g illuminated, the drive 102 is nearly full. The storage capacity represented the LEDs 204 may, of course, vary. For example, the green LEDs 204a,b,c could represent seventy percent of the capacity of the drive 102, yellow LEDs 204d,e twenty percent, and LEDs 204f,g ten percent. Alternatively, each LED 204 could represent a certain number of gigabytes.

FIG. 3 is a functional isometric view of the removable mass storage drive 102 of FIG. 1 showing in more detail another embodiment of the capacity indicator 104. The removable mass storage drive 102 once again includes a housing 300 in which electronic components (not shown) of the drive are contained, and includes a front panel 302 on which the capacity indicator 104 is positioned. In the embodiment of FIG. 3, the capacity indicator 104 is an LCD, LED, or other suitable type of display 304. In operation, the capacity-update component 110 generates the capacity-update signals to display the desired storage capacity information on the display 304. In the example shown in FIG. 3, the display 304 illustrates the percentage (75%) of the drive 102 that is full followed by the word “FULL.” Alternatively, the display 304 could display the capacity of the drive 102 that is unused or available, such as 25% where the drive is 75% full, or could display information in terms of gigabytes. The display 304 could also show both used and available storage capacity information. In each of these embodiments, the capacity-update component 110 would, of course, generate the proper capacity-update signals to properly update the information shown by the display 304.

The removable mass storage device 104 may be a hard drive or other type of mass storage device. Moreover, the capacity indicator 104 could be included on and perform the functions described above on a variety of different types of mass storage devices, both removable and fixed, such as floppy disk drives, tape cassette drives, compact disk read-write (CD-RW) drives, digital video disk read-write (DVD-RW) drives, and USB drives. With regard to the removable mass storage drive 104, one skilled in the art will understand suitable circuitry for controlling the capacity indicator 104 to display the desired storage capacity information and to update such information responsive to the capacity-update signals. Similarly, one skilled in the art will understand suitable programming instructions or circuitry for performing the functions of the capacity-update component 110. In another embodiment, the capacity-update component 110 is contained in the removable mass storage drive 102 through appropriate circuitry or programming instructions, and suitable circuitry and/or programming instructions for implementing this embodiment will also be understood by those skilled in the art.

Even though various embodiments of the present invention have been set forth in the foregoing description, the above disclosure is illustrative only, and changes may be made in detail and yet remain within the broad principles of the present invention. One skilled in the art will appreciate that the example embodiments described above do not limit the scope of the present invention, and will also understand various modifications, equivalents, and combinations of such embodiments are within the scope of the present invention. Therefore, the present invention is to be limited only by the appended claims.

1. A mass storage device operable to store data and having an overall storage capacity, the mass storage device including a panel on which a capacity indicator is positioned and the capacity indicator being operable to display either a used storage capacity or a free storage capacity of the mass storage device, or being operable to display both free and used storage capacities of the mass storage device.

2. The mass storage device of claim 1 wherein the mass storage device comprises a removable mass storage device.

3. The mass storage device of claim 2 wherein the removable mass storage device comprises a removable hard disk.

4. The mass storage device of claim 1 wherein the capacity indicator comprises at least one light-emitting device.

5. The mass storage device of claim 4 wherein each light emitting device comprises a light emitting diode.

6. The mass storage device of claim 5 wherein the mass storage device includes a plurality of light emitting diodes having a plurality of different colors.

7. The mass storage device of claim 1 wherein the capacity indicator comprises a liquid crystal display.

8. The mass storage device of claim 1 wherein the panel comprises a front panel of a housing containing electronics of the mass storage device.

9. The mass storage device of claim 1 wherein the mass storage device is adapted to receive capacity-update signals and wherein the capacity indicator is operable to display the storage capacity or capacities responsive to the capacity-update signals.

10. A computer system, comprising:
computer circuitry for executing programs and storing data; and
a mass storage device coupled to the computer circuitry and being operable to store data and having an overall storage capacity, the mass storage device including a panel on which a capacity indicator is positioned and the capacity indicator being operable to display either a used storage capacity or a free storage capacity of the mass storage device, or being operable to display both free and used storage capacities of the mass storage device.

11. The computer system of claim 11 wherein the computer circuitry includes a capacity-update component operable to determine the desired storage capacity of the mass storage device and to provide the determined storage capacity to the mass storage device, and wherein the capacity indicator displays the desired storage capacity responsive to the determined storage capacity provided by the computer circuitry.

12. The computer system of claim 10 further comprising:
at least one input device coupled to the computer circuitry; and
at least one output device coupled to the computer circuitry

13. The computer system of claim 10 wherein the mass storage device comprises a removable mass storage device.

14. The computer system of claim 13 wherein the removable mass storage device comprises a removable hard disk.

15. The computer system of claim 10 wherein the capacity indicator comprises at least one light-emitting device.

16. The computer system of claim 15 wherein each light emitting device comprises a light emitting diode.

17. The computer system of claim 16 wherein the mass storage device includes a plurality of light emitting diodes having a plurality of different colors.

18. The computer system of claim 10 wherein the capacity indicator comprises a liquid crystal display.

19. The computer system of claim 10 wherein the panel comprises a front panel of a housing containing electronics of the mass storage device.

20. A method of indicating a capacity of a mass storage device, comprising:
determining a capacity of the mass storage device; and
displaying an indication of the determined capacity.

21. The method of claim 20 wherein determining a capacity of the mass storage device comprises determining a used capacity of the mass storage device.

22. The method of claim 20 wherein displaying an indication of the determined capacity comprises displaying the determined capacity as a percentage of an overall storage capacity of the device.

23. The method of claim 20 wherein displaying an indication of the determined capacity comprises displaying different colors, each color corresponding to a portion of an overall storage capacity of the mass storage device.

24. The method of claim 20 wherein determining a capacity of the mass storage device comprises:
determining external to the mass storage device a capacity of the mass storage device; and
applying to the mass storage device signals indicating the externally determined capacity.

25. The method of claim 24 wherein determining external to the mass storage device a capacity of the mass storage device comprises periodically determining the capacity.
